(19) United States
(12) Patent Application Publication
(10) Pub. No.: US 2011/0038975 A1
(43) Pub. Date: Feb. 17, 2011

(54) APPARATUS FOR FORMING PATTERN ON LIGHT GUIDE PLATE

(76) Inventors: Deukil Park, Gyeonggi-do (KR); Choongyop Rhew, Gyeonggi-do (KR); Junkyu Lee, Gyeonggi-do (KR)

Correspondence Address: IPLA P.A., 3550 WILSHIRE BLVD., 17TH FLOOR, LOS ANGELES, CA, 90010, US

(21) Appl. No.: 12/989,914

(22) PCT Filed: May 19, 2008
(86) PCT No.: PCT/KR08/02776

§ 371 Date: Oct. 27, 2010

(51) Int. Cl. B29C 59/04; B29C 59/02

(52) U.S. Cl. 425/143

(57) ABSTRACT

The present invention relates to a pattern forming apparatus for forming a pattern on a Light Guide Plate (LGP) for backlight of a Liquid Crystal Display (LCD), a keypad, a telephone, a surface light source for lighting, etc. The apparatus includes a temperature control member provided at a top of a base mold and controlling a temperature of an LGP, a pattern mold provided at a top of the temperature control member, supporting a bottom side surface of the LGP, and having a plurality of patterns on a top surface such that the patterns can be replicated to the LGP, and a press roller unit for pressing a top surface of the LGP

### TECHNICAL FIELD

The present invention relates to a pattern forming apparatus for forming a pattern on a Light Guide Plate (LGP) for backlight of a Liquid Crystal Display (LCD), a keypad, a telephone, a surface light source for lighting, etc. More particularly, the present invention relates to an LGP pattern forming apparatus having a pattern mold having a plurality of patterns formed thereon for supporting a lower side surface of an LGP and simultaneously replicating the patterns to the LGP, and pressing a top surface of the LGP by a press roller unit and replicating the patterns of the pattern mold to the LGP, thereby being capable of preventing bending of the LGP and remarkably reducing working time not to mention a reduction of an installation cost.

### BACKGROUND ART

In general, a Light Guide Plate (LGP) is a plate for providing a path uniformly scattering and diffusing a scanned light from a light source into a constant region. The LGP is applied to a light-receiving type flat display device such as a Liquid Crystal Display (LCD) or a surface light source device used for a lighting signboard, etc.

The surface light source device using the LGP generally uses a scheme of arranging a light source such as a Cold Cathode Fluorescent Lamp (CCFL) or a Light Emitting Diode (LED).

Accordingly, the LGP is a core part for uniformly projecting light of a lamp or an LED to the front through the whole LGP surface and processing a point light source or a line light source into a surface light source. The LGP is manufactured in various shapes such as a round shape, a tetragonal shape, a diamond shape, etc. and is applied to the surface light source device.

FIG. 1 is a schematic partial cross section illustrating a conventional surface light source device.

As illustrated, the surface light source device includes an LGP 100, a reflector sheet 110 installed below the LGP 100, and one or more light generators 120 installed at one-side wall of the LGP 100 or each installed at both-side walls.

The light generator 120 is comprised of a light source 122 and a cover 121 in which the light source 122 is installed. The light generator 120 can allow the incidence of light irradiated from the light source 122 into the LGP 100.

A plurality of light guide patterns 105 printed with ink including bead shaped titanium oxide (TiO₂) and glass or acryl, etc. are formed on a rear surface the LGP 100 to scatter and diffuse light incident on a one surface of transparent acrylic resin.

The surface light source device forms a surface light source by making light irradiated from the light source 122 incident into the LGP 100, guiding the light through the LGP 100 as indicated by arrows, and then reflecting to the front the light having a relatively uniform luminance at each portion by the reflector sheet 110 and the light guide patterns 105.

### DISCLOSURE OF INVENTION

### Technical Problem

However, the light guide patterns 105 formed in a printing method as above have the following problems.

There is a disadvantage that a manufacturing and printing process of ink for forming the light guide patterns 105 is very complex and, because of a high rate of an error in which a portion of a printed part is dropped out or stained, etc., a yield of the light guide patterns 105 is a low percentage of about 80% to 90%, and it is impossible to recycle after removing a printing pattern, thus causing pollution and not being environment-friendly.

Particularly, because the light guide pattern 105 is of a scheme using light reflection of a printed ink material itself, a phenomenon of light absorption of the ink material itself inevitably occurs, thus deteriorating a light efficiency of the surface light source device.

In order to provide a solution to the above problems, a non-printing method such as an injection molding method using a mold, a stamping method using a pattern mold, a direct process method using a laser, a scratch method using a process lathe, etc. is applied.

However, the injection molding method requires repeating a mold modification work of tens or more of times for an optimization work for the patterns 105 and in addition, is difficult to meet a suddenly changing demand for the development of product kinds and also, if a product has a heavy thickness of 3 mm or more, increases a cooling-after-injection time to several minutes or so and reduces productivity. Inversely, if a product is very thin in thickness and wide in area, an injection progress is not smooth, thus causing an error of pattern 105 short-shot, etc.

The direct process method using the laser enables constant process according to a desired size with no influence from a deviation of a thickness of materials, and does not require an additional device such as a mold or a mask, etc. as well as does not coat separate substance on the patterns 105, thus achieving recycling and environment-friendship. However, the direct process method has a problem that, because all the patterns 105 should be formed one by one in regular sequence, a process time much increases and a phenomenon of bending of the LGP 100 occurs, thus decreasing a yield and greatly deteriorating productivity.

Also, the scratch method is to form the light guide patterns 105 by simply scratching in a line shape. The scratch method has a very big limitation in realizing the patterns 105 of a complex structure because only a line shape is possible, and has a critical disadvantage that, because foreign materials resulting from scratching are much generated, it is not suitable to a clean process.

The stamping method mounts a stamping mold on a round-shaped roller surface or mounts a stamping mold on a surface mold, presses the LGP 100 at high pressure, and replicates the light guide patterns 105 to the LGP 100 and therefore, in the case of a round shaped roller, there is a problem that stamping mold mounting and heating and mold manufacturing are very difficult.

Also, in the case of the surface mold, it is required to use a high-pressure equipment so as to uniformly replicate the patterns 105, causing a disadvantage that the equipment is expensive. Because the LGP 100 is pressurized at too high pressure, it is deformed and thus, there occurs an error in a product size. Thus, there is an additional problem of requiring again post-processing a product exterior after manufacturing.

Accordingly, manufacturing of an LGP 100 of an ultra thin type is impossible or a cost of equipment much increases. Also, because of a manufacturing error rate, a manufacturing cost relatively increases, thus greatly reducing price competitiveness.

For this, researches for various schemes for decreasing a manufacturing cost in the fields of LGP manufacturing method and equipment are being made.

### Technical Solution

The present invention includes a base mold,

a temperature control member provided at a top of the base mold and controlling a temperature of an LGP,

a pattern mold provided at a top of the temperature control member, supporting a bottom side surface of the LGP, and having a plurality of patterns on a top surface such that the patterns can be replicated to the LGP; and

a press roller unit for pressing a top surface of the LGP,

wherein at least any one of the base mold and the press roller unit is installed to be movable forward/backward such that the patterns of the pattern mold can be sequentially replicated to the LGP.

### ADVANTAGEOUS EFFECTS

Accordingly, by promoting the patterns replication of the whole surface by a line contact of the rotating roller, the present invention can greatly decrease a required pressure intensity of equipment and thus remarkably reduce an equipment manufacturing price.

Also, the patterns replication to the whole surface depending on the forward/backward motion of the base mold or the press roller unit are accomplished and thus, a single work process time is shortened and productivity can be greatly enhanced. In addition, because a method is to press an LGP product at a low pressure due to a line contact, a deformation of an outer size of the LGP caused by an excessive press force does not take place and additional LGP post-process is not required, thus being capable of reducing a work process count and a manufacturing cost.

### BRIEF DESCRIPTION OF DRAWINGS

FIG. 1 is a partial cross section schematically illustrating a conventional surface light source device;

FIG. 2 is an exploded perspective diagram of a surface light source device;

FIG. 3 is a configuration diagram of an exemplary embodiment of a Light Guide Plate (LGP) pattern forming apparatus of the present invention;

FIG. 4 is a flow diagram illustrating a work process of the present invention;

FIG. 5 is a configuration diagram of an exemplary embodiment further including a press force control sheet in the present invention;

FIG. 6 is a configuration diagram of an exemplary embodiment further including a variable electromagnet in the present invention;

FIG. 7 is a configuration diagram of another exemplary embodiment further including a press force control member in the present invention;

FIG. 8 is a configuration diagram of an exemplary embodiment of a temperature control member of the present invention;

FIG. 9 is a configuration diagram of an exemplary embodiment further including a speed control device in the present invention;

FIG. 10 is a configuration diagram of an exemplary embodiment further including a bending prevention unit in the present invention; and

FIG. 11 is a plan view of a pattern mold including the bending prevention unit of FIG. 10.

### DESCRIPTION OF MAIN PARTS OF THE DRAWINGS

10: base mold
15: transfer support
17: driver
20: temperature control member
21: temperature control sheet
22: cooling line
23: heating line
24: cooling temperature control unit
25: heating temperature control unit
28: heat insulation sheet
30, 30′ pattern mold
36: absorption passage
37: air absorption member
38: bending prevention unit
35, 105: patterns
40: press roller unit
45: roller support
47: rotating roller
50: press force control sheet
60, 60′ press force control member
62: variable electromagnet
65: magnetic force control unit
70: speed control device
100: LGP
110: reflector sheet
120: light generator
121: cover
122: light source
130: diffuser sheet
150: surface light source device

### BEST MODE FOR CARRYING OUT THE INVENTION

Hereinafter, the most preferable exemplary embodiment is described for a Light Guide Plate (LGP) and an LGP pattern forming apparatus according to the present invention in detail with reference to accompanying drawings.

However, the present invention is not limited to an exemplary embodiment disclosed below, and can be realized in different various types. Also, the present exemplary embodiment merely makes the disclosure of the present invention clear and is to provide the clear scope of the present invention to those skilled in the art.

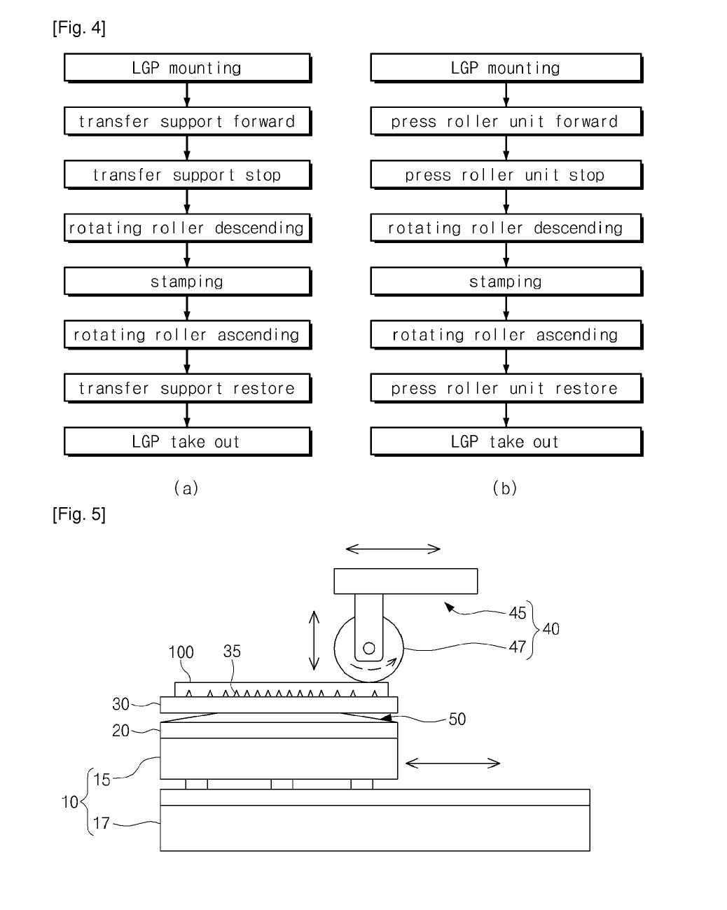

FIG. 2 is a schematic exploded perspective diagram illustrating a surface light source device 150 to which an LGP 100 is applied. FIG. 3 is a schematic configuration diagram of an exemplary embodiment of an LGP pattern forming apparatus of the present invention. FIG. 4 is a flow diagram of a work process of the present invention.

As illustrated in FIG. 2, the surface light source device 150 is comprised of a reflector sheet 110, the LGP 100, a diffuser sheet 130, and a light generator 120.

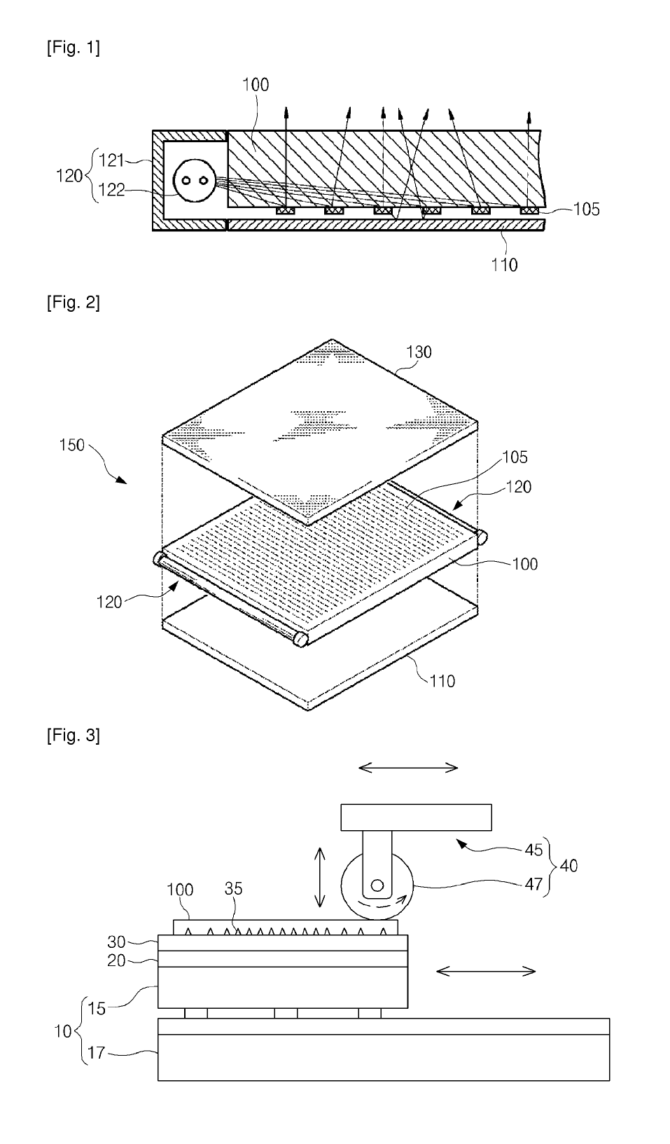

The reflector sheet 110 provided below the LGP 100 serves to reflect light, which is incident from the light source 122 (shown in FIG. 1) into the LGP 100, to the top. The reflector sheet 110 prevents a light loss of a rear surface part of the LGP 100 and its surface is coated with high reflection materials of a high reflection rate.

The diffuser sheet 130 is installed at a top of the LGP 100 and serves to scatter and diffuse light. The diffuser sheet 130 more uniformly diffuses the light scattered and projected from the LGP 100, to the front.

The light generator 120 including at least one or more light sources 122 for scanning light inside the LGP 100 is installed at a sidewall of the LGP 100.

Thus, after the light emitted from the light source 122 is incident inside through a side surface of the LGP 100, the light is guided and moved into the LGP 100 by the total reflection effect. Among the guided light, light reaching light guide patterns 105 is emitted to the front of the LGP 100 by an incident angle exceeding a total reflection threshold angle.

After the light emitted from the light guide patterns 105 is reflected from the reflector sheet 110 and again passes through the LGP 100, the light passes through the diffuser sheet 130 of the top of the LGP 100 and is emitted to the front.

The light guide patterns 105 are arranged such that a portion close to the light source 122 is formed at low density and a portion far from the light source 12 is formed at high density. By doing so, the LGP 100 forms a uniform surface light source for the whole surface.

As illustrated in FIG. 3, the LGP pattern forming apparatus of the present invention according to a first exemplary embodiment is comprised of a base mold 10, a temperature control member 20, a pattern mold 30, and a press roller unit 40. At least one of the base mold 10 and the press roller unit 40 is installed to be movable as indicated by arrows such that the patterns 35 of the pattern mold 30 can be sequentially replicated to the LGP 100.

Thus, the base mold 10 is formed of materials of metal, etc. having a thickness enough to prevent a deformation of the pattern mold 30. The base mold 10 can be comprised of a transfer support 15 and a driver 17.

The transfer support 15 of the base mold 10 is provided at a top of the driver 17 and is installed to be movable forward/backward through a generally applied mechanical method, thus being capable of moving forward/backward the temperature control member 20 and the pattern mold 30 that are sequentially laminated and installed on a top.

The temperature control member 20 is fixedly installed at a top of the transfer support 15 of the base mold 10. The temperature control member 20 serves to maintain the pattern mold 30 at a proper temperature such that the patterns 35 of the pattern mold 30 can be easily replicated to a bottom surface of the LGP 100.

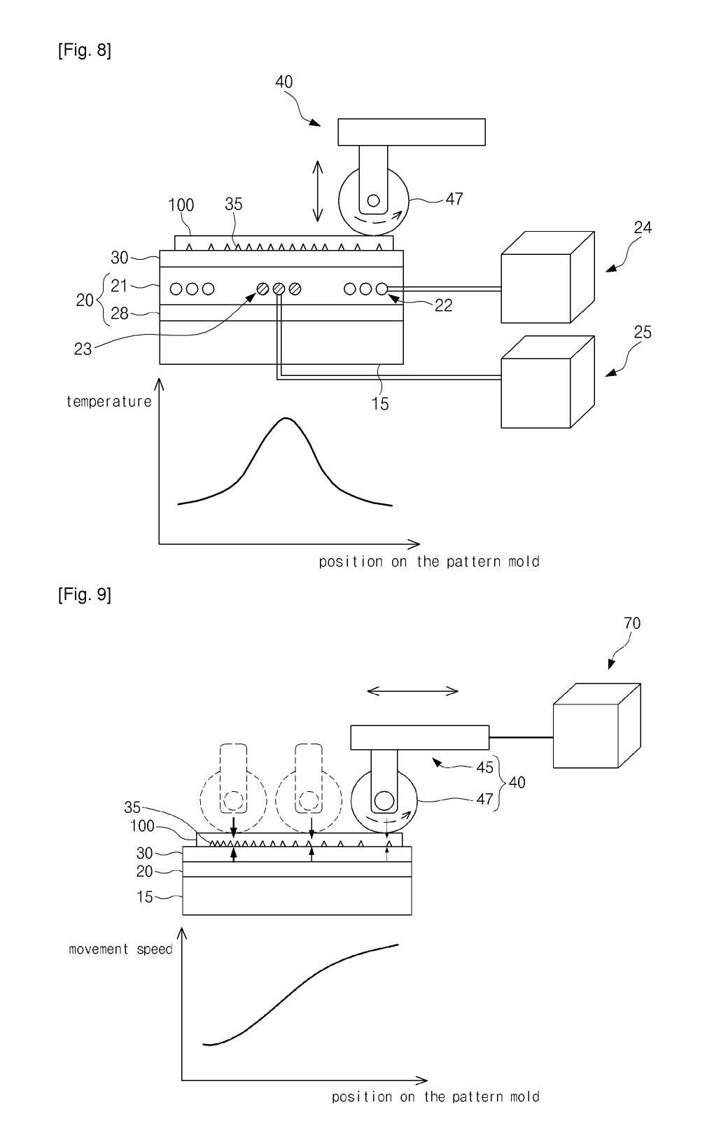

One exemplary embodiment of the temperature control member 20 is described in the following exemplary embodiment in detail with reference to FIG. 8.

The pattern mold 30 is to replicate the light guide patterns 35 to a bottom surface of the LGP 100. The pattern mold 30 is fixedly installed at an upper side of the temperature control member 20. The light guide patterns 35 requiring finally replicating to the LGP 100 are shaped with engraving or embossing on a surface.

As a method for installing the light guide patterns 35 on the pattern mold 30, there are methods of a mechanical direct process of a lathe, etc., an etching, sanding, laser process, etc.

The LGP 100 is mounted on a top surface of the pattern mold 30.

The press roller unit 40 presses a top surface of the LGP 100 mounted on the top of the pattern mold 30 such that the patterns 35 of the pattern mold 30 are replicated to the LGP 100. The press roller unit 40 is comprised of a rotating roller 47 and a roller support 45.

The rotating roller 47, which is of a cylindrical shape, is supported by the roller support 45 and presses a top surface of the LGP 100, and is desirably installed to be movable up/down at this time.

The roller support 45 is provided to be movable forward/backward such that, as the rotating roller 47 rotates, it can press the top surface of the LGP 100 in a one side direction.

Like the base mold 10, the roller support 45 is installed to be movable in a mechanical method by a separate driver (not shown).

Thus, the present invention manufactures the LGP 100 such that the light guide patterns 35 of the pattern mold 30 are replicated to the LGP 100 by forward/backward advancing the pattern mold 30 or the rotating roller 47 in a state where the LGP 100 is positioned between the pattern mold 30 and the cylindrical rotating roller 47 and thus the LGP 100 is pressed at both up/down sides by the pattern mold 30 and the rotating roller 47.

A bottom surface of the LGP 100 gets in contact with a top surface of the pattern mold 30.

A protection film (not shown) can be additionally installed on a top surface of the LGP 100 to prevent a scratch due to the rotating roller 47.

Thus, the replication of the patterns 35 to the LGP 100 is achieved by forming the patterns 35 of a required shape on a top surface of the pattern mold 30, mounting the pattern mold 30 on a top of the base mold 10, and pressing a top surface of the LGP 100 by the press roller unit 40. At this time, the temperature control member 20 can be such that a heating unit and a cooling unit can be positioned according to a temperature distribution design so that a temperature difference is generated depending on a position of the LGP 100.

A press method of the press roller unit 40 may be various methods of oil press, air press, electric motion, magnetic force, gravity, etc.

Meantime, a work process of the present invention is described in detail with reference to FIG. 4.

As each illustrated in FIGS. 4A and 4B, the present invention can operate in two methods.

FIG. 4A illustrates an operation process when the base mold 10 is installed movable. As illustrated, if the LGP 100 is mounted on a top of the pattern mold 30, the transfer support 15 of the base mold 10 advances forward and then stops such that the rotating roller 47 is positioned at an edge part of the LGP 100.

At this time, the rotating roller 47 of the press roller unit 40 descends while pressing a top of the LGP 100 and allows execution of a stamping process, thereby allowing the patterns 35 of the pattern mold 30 to be replicated to a bottom surface of the LGP 100.

At this time, the base mold 10 moves and simultaneously the temperature control member 20, the pattern mold 30, and the LGP 100 move. The rotating roller 47 is rotated by a friction on a contact surface with the LGP 100. A portion of the LGP 100 getting in line contact with the rotating roller 47 is compressed by the rotating roller 47 and the pattern mold 30. At this time, the patterns 35 on the pattern mold 30 are replicated to the LGP 100 by high pressure and temperature.

If the patterns 35 replication is completed, the rotating roller 47 again ascends. The transfer support 15 is restored to the original position by backward motion and waits for next work. If the backward motion of the transfer support 15 is completed, then the LGP 100 is taken out.

FIG. 4B illustrates an operation process when the press roller unit 40 is installed to be movable. In a state where the LGP 100 is mounted on a top of the pattern mold 30, the rotating roller 47 is positioned at an edge part of the LGP 100 by a forward motion of the press roller unit 40 and then stops. At this time, the rotating roller 47 descends and the press roller unit 40 advances forward, thereby achieving a stamping work.

After the patterns 35 are replicated by stamping, the rotating roller 47 again ascends, and the press roller unit 40 is restored to the original position by backward motion.

### MODE FOR THE INVENTION

Other exemplary embodiments of the present invention are described below in detail with reference to FIGS. 5 to 11.

FIG. 5 is a configuration diagram further including a press force control sheet such that a press force is controllable. As illustrated, the press force control sheet 50 is provided between the temperature control member 20 and the pattern mold 30.

The press force control sheet 50 is positioned at a bottom surface of the pattern mold 30 and controls a press force that the LGP 100 receives from the rotating roller 47 through a minute slant plate method in which a thickness of a required portion gradually increases or decreases. It is a method in which, if the LGP 100 is pressed by the press roller unit 40, a difference of a pressure forwarded to the LGP 100 is variable depending on a height by portion of the press force control sheet 50.

Because a density and depth of the patterns 35 should increase together at a portion relatively far from the light source 122 (shown in FIG. 1) on the LGP 100, there is a need to press the LGP 100 with higher pressure.

Accordingly, it is a method in which, if a thickness of the press force control sheet 50 of this portion (e.g., a center of the LGP) is formed relatively thick, the LGP 100 is firmly supported at this portion, thereby suffering higher pressure compared to the circumference.

That is, slant surfaces each formed at both sides of the press force control sheet 50 lead to keeping the press force control sheet 50 and bottom surfaces of both sides of the pattern mold 30 in a separated state. At this time, if a top of the LGP 100 is pressed by the rotating roller 47, minute bending is generated downside at both sides of the pattern mold 30 not firmly supported. Thus, the LGP 100 suffers a relatively lower pressure than the center.

Also, although not illustrated, if the light source 122 is installed only at one side part of the LGP 100 in the surface light source device 150, the patterns 35 of the LGP 100 should sequentially increase in density as getting far from the light source 122. Thus, it is desirable that the slant surfaces of the press force control sheet 50 are wholly formed to downward incline from a portion of a high density of the patterns 35 of the LGP 100 to a portion of a low density.

If the whole top surface of the press force control sheet 50 is formed as a slant surface, the pattern mold 30 is mounted in a slant state correspondingly to the slant surface of the press force control sheet 50.

Accordingly, as described above, if the press force control sheet 50 having a height deviation is additionally installed, constant initial applied pressure and height are adjusted for the rotating roller 47 and then, the base mold 10 or the press roller unit 40 moves, a press force is possible to be differently applied by a height difference of the press force control sheet 50 depending on a position of the LGP 100.

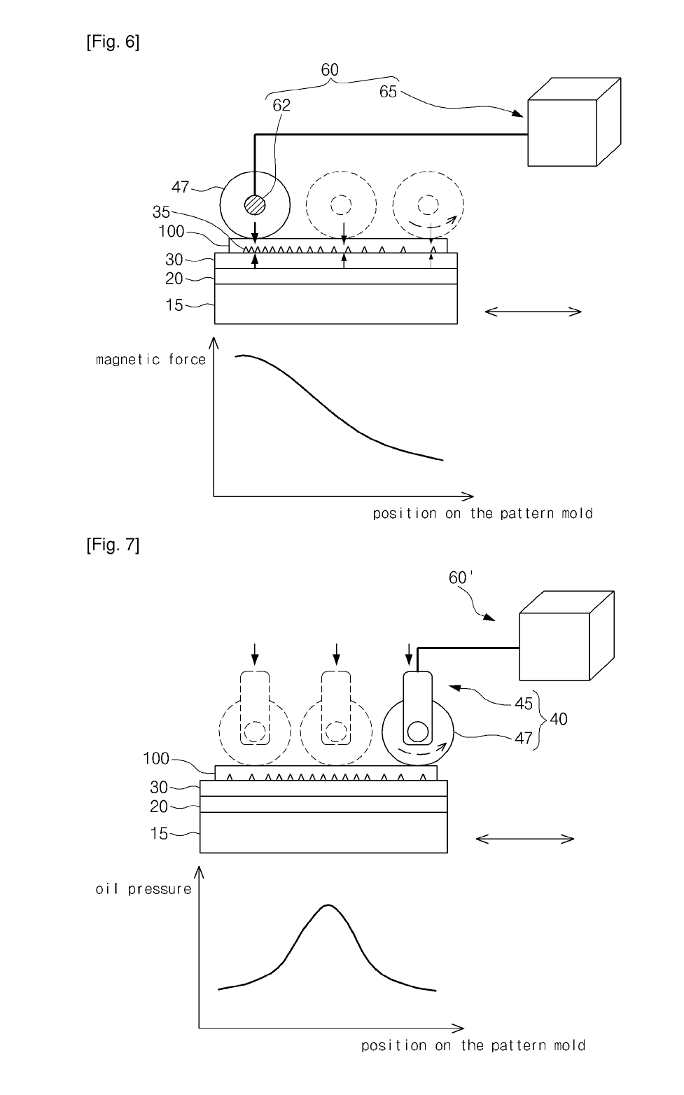

FIG. 6 is a configuration diagram of another exemplary embodiment further including a press force control member 60 controlling a press force, and illustrates the patterns 35 of the pattern mold 30 applied to manufacturing of the LGP 100 if the light source 122 is installed only at one side of the LGP 100 in the surface light source device 150.

Thus, the patterns 35 are formed to sequentially increase in density from one side to the other side of the pattern mold 30.

The press force control member 60 is constructed to install a variable electromagnet 62 connecting with a magnetic force controller 65 at a center of the rotating roller 47 of the press roller unit 40 and apply an external power source.

At this time, a high press force can be easily obtained by supplying a high external power source and increasing an intensity of a magnetic force at a portion (i.e., a portion of a high pattern density) requiring a high pressure depending on a position of the rotating roller 47 in the LGP 100.

Accordingly, as illustrated in a graph, a magnetic force is set such that, as going from a portion of a high density of the patterns 35 to a portion of a low density, its intensity gradually decrease in proportion to this.

At this time, a press force of the rotating roller 47 gradually decreases in proportion to an intensity of a magnetic force and thus, can be simply and conveniently controlled depending on each position on the LGP 100.

FIG. 7 is a configuration diagram of another exemplary embodiment further including a press force control member 60′. The press force control member 60′ is comprised of an oil press for enabling a control of a press force of the rotating roller 47.

Thus, the oil press controls an oil pressure or air pressure such that the rotating roller 47 can obtain a higher press force in a desired position.

Thus, as illustrated in a graph, an oil pressure decreases such that a press force decreases at both side parts of the LGP 100 where a density of the patterns 35 is low, and a control can be such that an oil pressure greatly acts at a center of the LGP 100 where the density of the patterns 35 is high.

FIG. 8 illustrates a configuration diagram of the present invention including an exemplary embodiment of a temperature control member 20. This does not intend to limit the scope of the present invention, but a temperature control sheet 21 of various types where a general heating heater is installed can be used.

As illustrated, the temperature control member 20 is positioned between the base mold 10 and the pattern mold 30, and is comprised of an heat insulation sheet 28 and a temperature control sheet 21.

The heat insulation sheet 28 is fixedly installed at a top of the base mold 10 and serves to shield forwarding of a heat of the temperature control sheet 21 to the base mold 10, thereby serving to preventing forwarding of a heat to an unnecessary place as well as improving heat efficiency. It is desirable to use materials such as a ceramic, etc. having good insulation performance, excellent machinability, and high internal pressure.

A heating line 23 and a cooling line 22 each are installed in the temperature control sheet 21.

The temperature control sheet 21 is formed of materials of excellent heat conductivity. In a state where the LGP 100 is mounted in the surface light source device 150 (shown in FIG. 2), a plurality of cooling lines 22 are connected and installed in a portion corresponding to both side parts of the LGP 100 adjacent to the light source 122. The heating lines 23 are connected and installed in a portion corresponding to a center of the LGP 100 positioned in a place far from the light source 122.

At this time, the heating line 23 and the cooling line 22 each are connected to a heating temperature controller 25 and a cooling temperature controller 24 and are provided to enable a temperature control.

The heating line 23 can be realized in a method of directly inserting using a heater or injecting and circulating a relatively hot solution. The cooling line 22 can be realized in a method of performing cooling using a flow of cold air or injecting and circulating a relatively cold solution.

Accordingly, as illustrated in a graph, the temperature control member 20 is heated such that a temperature distribution of the pattern mold 30 is different depending on a position of the LGP 100.

According to inventor's experiment, when a temperature of a heated portion is equal to 80 to 130 degrees and a temperature of a cooled portion is within a range of 10 to 60 degrees, machinability of desired patterns could be obtained.

FIG. 9 illustrates a configuration diagram further including a speed control device 70 and, as in FIG. 6, illustrates the patterns 35 of the pattern mold 30 sequentially increasing in density from one side to the other side.

As illustrated, the press roller unit 40 further includes the speed control device 70 being capable of controlling a movement speed of the press roller unit 40.

It is possible that at a portion where the patterns 35 replicated to the LGP 100 should be formed to have high density and also deep depth, a movement speed of the press roller unit 40 decreases through the speed control device 79 and press time increases, and at a portion where the patterns 35 are low in density and relatively low in depth, press time decreases.

Thus, in addition to a direct press force control through the rotating roller 47, as illustrated by a dotted line and in a graph, even a method of, as going from a portion of a high density of the patterns 35 to a portion of a low density, gradually increasing a movement speed of the press roller unit 40 in proportion to this, thereby controlling press time through movement speed control and controlling a replication depth of the light guide patterns 35 is possible.

A method of varying press time can be achieved in a way to vary a movement speed of the base mold 10 or the press roller unit 40 by position.

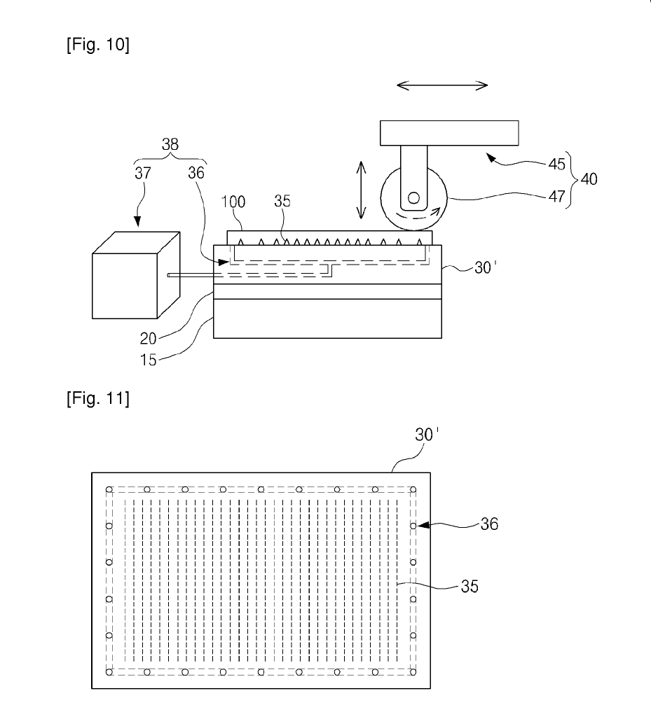

FIG. 10 illustrates a configuration diagram further including a bending prevention unit 38 for preventing bending of the LGP 100. FIG. 11 illustrates a plan view of a pattern mold 30′.

The bending prevention unit 38 is to prevent the LGP 100 from being bent due to pressing of the press roller unit 40 and heating of the temperature control member 20. The bending prevention unit 38 vacuum-absorbs the LGP 100 on the pattern mold 30′ and prevents the bending.

The bending prevention unit 38 is comprised of an absorption passage 36 installed in the pattern mold 30′ and an air absorption member 37.

The absorption passage 36 is a duct for passing air and, as illustrated in FIG. 11, its upper end is formed to communicate with a top of the pattern mold 30′ and is installed in plural to be spaced a predetermined distance apart along a circumference of the LGP 100.

At this time, the branched respective absorption passages 36 are connected and installed to communicate with each other, and are connected with a separate air absorption member 37 through a side surface part of the pattern mold 30′.

The air absorption member 37, which is a pump system such as a mechanical vacuum pump, a momentum transfer type vacuum pump, or an oil pressure type vacuum pump, vacuum-absorbs the LGP 100 by forcibly discharging air of the absorption passage 36 to the external by a pumping force.

A vacuum pad (not shown) may be installed at a top side surface of the pattern mold 30′ to which the LGP 100 is absorbed, to prevent a scratch caused by absorption.

Also, the bending prevention unit 38 is not limited to this, but a general heating heater (not shown) may be mounted inside the rotating roller 47 such that bending of the LGP 100 can be prevented by allowing the rotating roller 47 of the press roller unit 40 to heat and press the LGP 100.

Meantime, although not illustrated in the drawings, a device of forming light guide patterns at both surfaces of the LGP may also continuously perform a primary stamping work and a secondary stamping work.

That is, by sequentially automatically operating a work of coating a protection film on a primary process surface before a secondary stamping work, a work of turning the LGP 100 over, and a work of removing a protection film on a secondary process surface and enabling a both-surface light guide pattern work, it is henceforth possible to reduce an optical film such as a prism sheet, a diffuser sheet, etc. and to fundamentally stop the generation of bending of the LGP 100 by a both-surface rolling work.

The press force control sheet 50, the press force control members 60 and 60′ and the temperature control member 20 of the present invention are such that a press force can be differently applied depending on a position of the rotating roller 47 of the press force roller unit 40, and are means for, when forming the patterns 35 on the LGP 100, controlling a replication depth using a pressure deviation and a temperature deviation depending on a position of the LGP 100. The press force control sheet 50, the press force control members 60 and 60′ and the temperature control member 20 can provide a method of controlling all density and depth of the light guide patterns 35 by increasing temperature and pressure at a portion of a relatively high density of the patterns 35 and decreasing temperature and pressure at a portion of a low density of the patterns 35.

Accordingly, the present invention can obtain a greater light efficiency by decreasing a density and depth of the patterns 35 at a place close to the light source 122 within the LGP 100, and increasing the density and depth of the patterns 35 at a place far from the light source 122.

The present invention is described with reference to exemplary embodiments illustrated in the drawings, but this is merely exemplary. It will be understood by those skilled in the art that various modifications from this and other equivalent exemplary embodiments can be made.

Accordingly, the true technological protection scope of the present invention should be defined by the technological spirit of the claims appended.

### INDUSTRIAL APPLICABILITY

The present invention relates to a pattern forming apparatus for forming a pattern on an LGP for backlight of an LCD, a keypad, a telephone, a surface light source for lighting, etc. By positioning the LGP at a top of a pattern mold in which a plurality of patterns are formed, pressing the LGP by a press roller, and replicating the patterns to the LGP, the present invention can not only prevent bending of the LGP and reduce an installation cost but also can greatly reduce a work process time, thus enabling the effective use in an LGP manufacturing process.

1. A light guide plate (LGP) pattern forming apparatus comprising:
a base mold;
a temperature control member provided at a top of the base mold and controlling a temperature of an LGP;
a pattern mold provided at a top of the temperature control member, supporting a bottom side surface of the LGP, and having a plurality of patterns on a top surface such that the patterns can be replicated to the LGP; and
a press roller unit for pressing a top surface of the LGP,
wherein at least any one of the base mold and the press roller unit is installed to be movable forward/backward such that the patterns of the pattern mold can be sequentially replicated to the LGP.

2. The apparatus of claim 1, wherein the base mold comprises a transfer support supporting a low side part of the temperature control member and a driver installed such that the transfer support is movable.

3. The apparatus of claim 1, wherein the press roller unit comprises:
a rotating roller for pressing the top surface of the LGP; and
a roller support supporting the rotating roller and installed such that the rotating roller is movable.

4. The apparatus of claim 1, wherein a press force control sheet supporting the pattern mold is provided between the pattern mold and the temperature control member, and the press force control sheet is formed to have a slant surface at part of a top surface or the whole surface such that a press force applied to the LGP by the press roller unit differently acts depending on a position.

5. The apparatus of claim 1, wherein the press roller unit further comprises a press force control member such that a press force is differently applied to a top surface of the LGP depending on a movement of the LGP.

6. The apparatus of claim 5, wherein the press force control member is a variable electromagnet for making an intensity of a magnetic force controllable such that a magnetic force can differently act depending on the movement of the LGP.

7. The apparatus of claim 5, wherein the press force control member is an oil press in which a press force control is possible.

8. The apparatus of claim 1, wherein at least any one of the base mold and the press roller unit further comprises a speed control device making a movement speed control possible such that a press time of the press roller unit can differently act depending on a movement of the LGP.

9. The apparatus of claim 1, wherein the pattern mold further comprises a bending prevention unit for firmly adhering and fixing the LGP such that the LGP is not deformed by a press force of the press roller unit.

10. The apparatus of claim 9, wherein the bending prevention unit comprises:
an absorption passage formed inside the pattern mold such that one end communicates with an upper side part of the pattern mold approaching a circumference of the LGP; and
an air absorption member coupled to the other end of the absorption passage.

11. The apparatus of claim 9, wherein the bending prevention unit is a heating heater installed in the press roller unit to heat while pressing the LGP.

12. The apparatus of any one of claims 1 to 11, wherein the temperature control member is comprised of an heat insulation sheet and a temperature control sheet sequentially laminated and provided on the base mold, and the temperature control sheet inside-installs a heating line and a cooling line each comprising a heating temperature controller and a cooling temperature controller.

13. The apparatus of claim 12, wherein the cooling line of the temperature control sheet is positioned correspondingly to a portion adjacent to a light source at the time of LGP assembly, and the heating line is installed to be positioned correspondingly to a portion relatively far from the light source.
